(19) United States
(12) Patent Application Publication
(10) Pub. No.: US 2021/0054827 A1
(43) Pub. Date: Feb. 25, 2021

(54) System and Method for Detecting Bird and Bat Casualties Near Wind Turbines

(71) Applicant: Kevin Heist, Minneapolis, MN (US)

(72) Inventor: Kevin Heist, Minneapolis, MN (US)

(21) Appl. No.: 16/999,945

(22) Filed: Aug. 21, 2020

Related U.S. Application Data
(60) Provisional application No. 62/890,967, filed on Aug. 23, 2019.

(51) Int. Cl. F03D 17/00; F03D 7/04; F03D 80/00

(52) U.S. Cl. CPC F03D 17/00; F03D 7/046; F03D 80/00; F05B 2270/8041; F05B 2270/303; F05B 2270/708; F05B 2260/80

(57) ABSTRACT

A system of detecting avian casualties includes an imaging capture device mounted on a nacelle or tower of a wind turbine. The thermal imaging device has a field of view, and the thermal imaging device is connected to a computing system configured to determine the number of avian casualties caused by the plurality of blades or by collision with any part of the turbine.

### TECHNICAL FIELD

This disclosure relates generally to systems and methods for detecting birds and bats near wind turbines.

### BACKGROUND

Wind turbines pose significant risk to birds or bats that fly through the air space in which the turbine blades move. Methods for monitoring direct impacts to birds and bats as a result of collision or barotrauma at terrestrial wind energy facilities require large amounts of labor and the results include a high degree of uncertainty regarding both the quantity and timing of fatalities. At offshore wind energy facilities, there are currently no reliable methods for monitoring direct impacts to birds and bats.

The effect that wind turbines have on birds and bats is often studied by researchers. One challenge for accurately assessing the risk of wind turbines to birds and bats is the difficulty in determining the number of birds and bats that are killed as a result of collisions with the wind turbine. Commonly, researchers manually count the number of dead birds and dead bats found on the ground near the wind turbines. However, this method of counting is inaccurate, time-consuming, and expensive.

These land-based searches must account for substantial effects on detection rates attributable to 1) varying search intervals among studies, 2) varying searcher efficiency among personnel and land cover types, and 3) varying rates of carcass removal by scavengers among sites and time of year. None of these constraints apply to a camera-based fatality detection system. Various camera-based systems have been used to monitor the movement of birds and bats around wind turbines, but there are technical limitations to these approaches and their outputs do not provide a reliable quantification of casualties.

### SUMMARY

The present disclosure relates generally to a system and method for detecting avian casualties caused by wind turbines.

One aspect relates to a system of detecting avian casualties near a wind turbine. The system includes a computing system including at least one computing device, the computing system having at least one processor communicatively coupled to a memory, the memory storing computer-executable instructions comprising a software tool. The software tool causes the computing system to determine a field of view, and determine whether an avian is detected within the field of view. When an avian is detected in the field of view, a location of the avian is determined and the location is saved in a lookup table. When no avian is detected within the field of view, a most recent location of the avian is recorded in the lookup table, and it is determined if the final location is near an edge of the field of view.

Another aspect relates to a method of detecting avian casualties near a wind turbine. The method includes determining a field of view, and determining whether an avian is detected within the field of view. When an avian is detected in the field of view, a location of the avian is determined and the location is saved in a lookup table. When no avian is detected within the field of view, a most recent location of the avian is recorded in the lookup table, and it is determined if the final location is near an edge of the field of view.

In yet another aspect, a system of detecting avian casualties near a wind turbine is described. The system includes a thermal imaging camera and a computing system. The thermal imaging camera is mounted on a rear of a nacelle or tower of a wind turbine. The computing system is connected to the thermal imaging camera and includes at least one computing device, the computing system having at least one processor communicatively coupled to a memory, the memory storing computer-executable instructions comprising a software tool. The software tool causes the computing system to determine a field of view, and determine whether an avian is detected within the field of view. When an avian is detected in the field of view, a location of the avian is determined and the location is saved in a lookup table. When no avian is detected within the field of view, a most recent location of the avian is recorded in the lookup table, and it is determined whether a casualty event has occurred via a flight pattern analysis or a change in avian temperature analysis.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example embodiment of an avian detection system mounted on a wind turbine according to the present disclosure.

FIG. 2 illustrates an alternative example embodiment of an avian detection system mounted on a wind turbine according to the present disclosure.

FIG. 3 illustrates an example embodiment of a field of view of the camera of FIG. 1 or FIG. 2.

FIG. 4 illustrates an example method for determining avian casualties.

FIG. 5 illustrates an example method for determining the number of avian casualties by video capture and manual review.

FIG. 6 illustrates an example method for determining the number of avian casualties as indicated by the avian remaining in the field of view.

FIG. 7 illustrates an example method for determining the number of avian casualties as indicated by avian flight path or temperature trend.

FIGS. 8A and 8B illustrate an example of data produced by image analysis.

FIG. 9 illustrates an example method of determining the number of avian fatalities casualties by machine learning.

FIG. 10 illustrates an example method of determining the location of an avian that has suffered a casualty.

FIGS. 11A and 11B illustrate example charts for monitoring avian temperature.

FIG. 12 illustrates an example environment illustrating avian flight paths.

FIG. 13 illustrates an example block diagram of a computing system.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION OF DRAWINGS

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

Commonly, cameras are used to monitor birds and bats. Thermal imaging is a powerful technology that enables nighttime detection of wildlife at considerable distances (e.g., compared to acoustic detection) and with a relatively high degree of specificity and detail (e.g., compared to radar). Thermal cameras have been used in recent studies to examine bird and bat interactions with wind turbines. These systems have occasionally captured blade strikes (which are often difficult to decipher when using ground-based cameras with upward or side-view perspectives), but have been used primarily to study bird and bat behavior in the rotor-swept zone (RSZ) airspace.

The present system monitors collision or barotrauma events from above using a camera, for example, a thermal videography-enabled camera. The monitoring system is able to identify birds and bats falling into an area of known size under the turbine (camera field of view) with a high degree of reliability. The camera is connected to a computing system running a monitoring system application.

Within the camera field of view, injured or dead birds or bats should be easily identifiable as they land on the ground or enter water or vegetation beneath the turbine. The temperature and thermal emissivity of birds and bats differs from those of the ground, water, and other surfaces onto which a wind turbine is installed. This causes a difference in thermal infrared radiation between avians (birds and bats) and the terrain or waterbodies over which they fly. As a result, it is possible to detect the presence and movement of birds and bats using a thermal camera placed high above ground, providing an overhead view of the airspace and ground below the camera. Thermal image analysis can filter out radiation from background surfaces to isolate objects with distinct thermal characteristics such as birds and bats. Observing bird and bat movement patterns from above allows healthy animals flying through the field of view to be distinguished from dead or injured animals falling to the surface below.

Offshore fatality monitoring presents many unique challenges; however, this environment provides a thermal backdrop that is actually advantageous for nocturnal fatality detection by thermal imaging. If, in an example embodiment of the system, a camera is mounted on the rear of the nacelle, the camera's field of view on the leeward side of the turbine is free of visual interference from blades, and winds may push airborne carcasses to this side of the wind turbine. If mounted on the turbine tower, interference from blades can be digitally removed from the video feed to provide a view that is intermittently blocked but still useful for casualty detection.

The monitoring system described herein is able to identify birds and bats falling into an area of known size under the turbine (camera field of view) with a high degree of reliability. Fatality rate estimates based on the temporal and spatial distribution of carcasses are more accurate than those from traditional fatality searches at land-based facilities.

A software application on an electronic computing device, typically a server computer, can be used to extract information, such as the identification of an avian, a flight pattern of the avian, and/or a temperature of the avian in the field of view. In some implementations, the software application can use artificial intelligence (AI). AI can be helpful in identifying an avian within the field of view, using an identified format to detect a temperature of an avian or to detect a flight pattern of an avian.

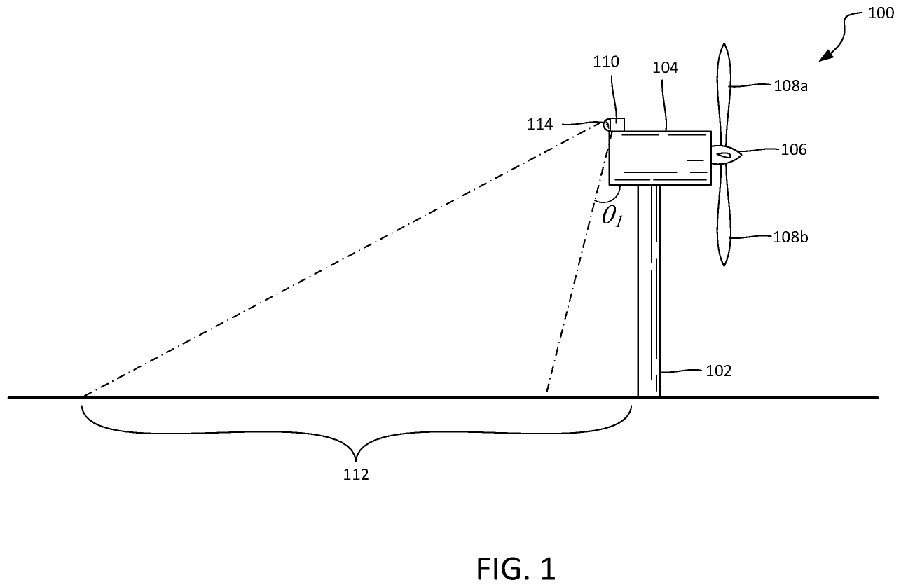

FIG. 1 illustrates an example embodiment of an image capture device 110 mounted on a wind turbine 100 for monitoring avian collision events. An image capture device 110 may be a camera, video camera, thermal imaging device, or other similar device. As shown in the figure, the wind turbine 100 includes a tower 102, a nacelle 104, a rotor 106, and a plurality of blades 108a, 108b. An image capture device 110 is mounted on the rear of the nacelle 104, with its lens 114 pointed away from the plurality of blades 108a, 108b. The image capture device 110 is pointed away from the wind turbine 100 and down towards the ground. The image capture device 110 observes a field of view that extends from an area near the base of the wind turbine 100 to a distance 112 on the ground. In an embodiment, the camera lens 114 is pointed towards the ground at an angle Θ₁ of 30° measuring perpendicular to the ground. In another example, the angle Θ₁ may be from about 0° to about 45°.

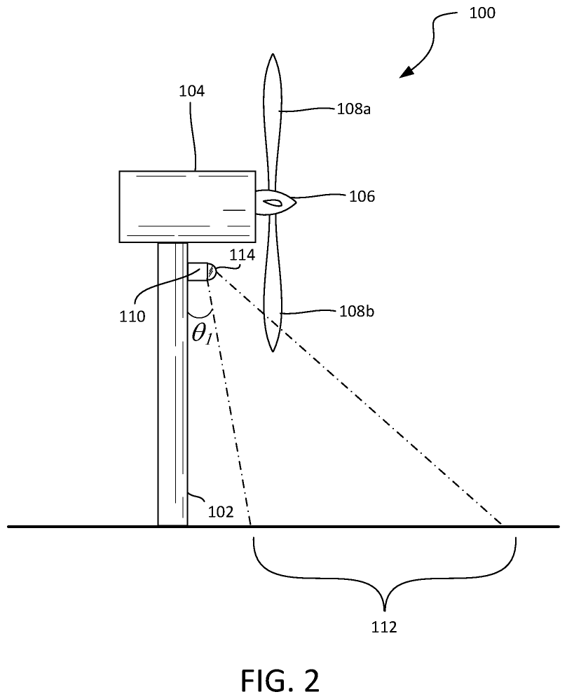

FIG. 2 illustrates an example embodiment of an image capture device 110 mounted on a wind turbine 100 for monitoring avian collision events. As shown in the figure, the wind turbine 100 includes a tower 102, a nacelle 104, a rotor 106, and a plurality of blades 108a, 108b. An image capture device 110 is mounted near the top of the tower 102, with its lens 114 pointed downward. The image capture device 110 observes a field of view that extends from an area near the base of the wind turbine 100 to a distance 112 on the ground. In an embodiment, the camera lens 114 is pointed towards the ground at an angle Θ₁ of 30° measuring perpendicular to the ground. In another example, the angle Θ₁ may be from about 0° to about 45°.

The image capture device 110 may have a variety of different functions. For example, the image capture device 110 may be a thermal imaging camera sensing long-wave or mid-wave thermal infrared radiation. Further, the image capture device 110 has recording capabilities, as well as cloud-based connectivity. In other embodiments, the image capture device 110 may be a low-resolution camera. The image capture device 110 may also have night vision capabilities by sensing reflected radiation in the near-infrared range of the electromagnetic spectrum, and the ability to record events in a variety of weather conditions.

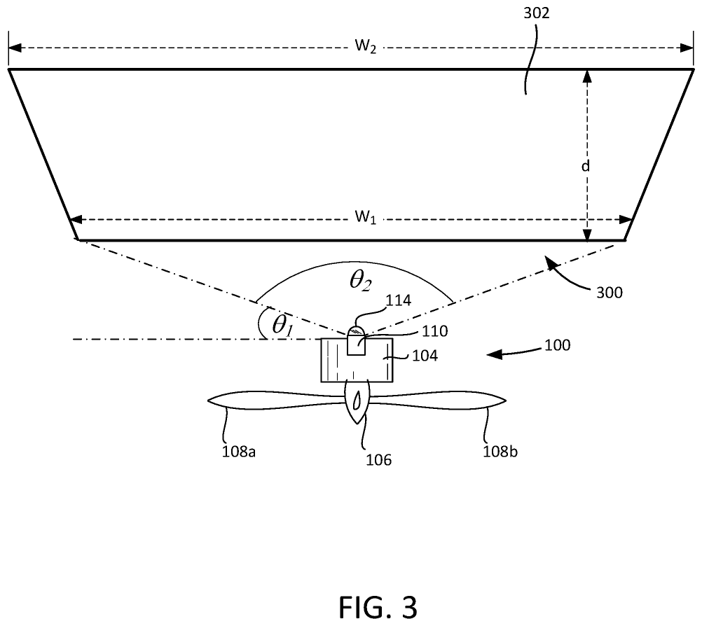

FIG. 3 illustrates an example embodiment of the field of view of the image capture device 110. As shown, the image capture device 110 faces away from the blades 108a, 108b of the wind turbine 100. In an example, the camera lens 114 is pointed down towards the ground and has a 30° vertical view spread from the tower 102. In other examples, the camera lens 114 may have a different vertical view spread, such as 0°, 10°, or 15°, relative to the tower 102.

The field of view 300 is defined as the three-dimensional area from the camera lens 114 to the area of the ground 302. The area of the ground 302 has a width w₁, w₂, and a depth d, but is not necessarily rectangular. In the embodiment shown, the area of the ground 302 has a trapezoid shape with a width w₁ of 72 meters at a distance of 100 meters from the tower 102, a width w₂ of 84 meters at a distance of 115 meters from the tower 102, and a depth d of 58 meters. The area of the ground 302 is 6,235 square meters. Other areas of the ground 302 are possible, depending on the capabilities of the image capture device 110. For example, an area from about 3,000 square meters to about 10,000 square meters is possible.

The image capture device 110 is connected to a computing system (not shown). The computing system includes at least one processor communicatively coupled to a memory and the memory stores computer-executable instructions comprising a software tool.

The computing system is more efficient and faster than traditional systems. Efficiency is increased when the system identifies the difference between a non-casualty event and a casualty event. A non-casualty event is not given further review, while a casualty event is further reviewed to determine the type of casualty and where the avian is located. Further, the system is able to utilize a lookup table in real time to determine a change in location of the avian.

The system can also include a Global Positioning System (GPS) to determine the location of an avian casualty. The GPS coordinates of the avian casualty can be uploaded and saved to a cloud-based server for review and storage.

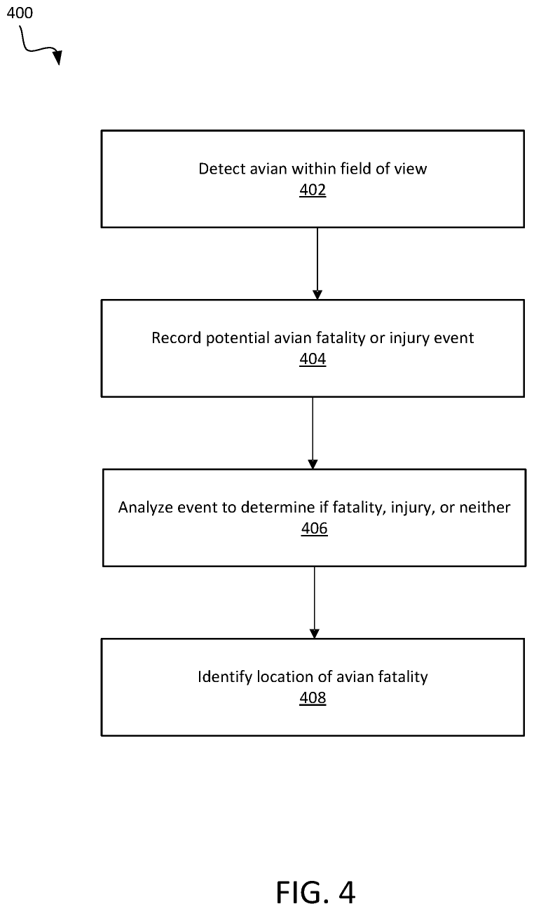

FIG. 4 illustrates an example method 400 of detecting an avian casualty event. An avian casualty event is defined as an avian fatality or an avian injury caused by a wind turbine. As used herein, avian defines any type of flying animal, such as birds and bats. Insects are generally too small to be counted in the embodiment and methods described herein. However, as imaging capabilities increase, insects may be counted.

At step 402, avians within the field of view of the image capture device 110 are detected. As described in more detail below, in an example embodiment, the field of view has a ground coverage of more than 6,000 square meters.

At step 404, potential avian casualty events are identified and recorded. For example, a potential avian casualty event may be the identification of an avian that enters the field of view, but does not exit the field of view, or exits the field of view very slowly or with delay. In another example, an avian casualty may be identified when the flight path of an avian is interrupted or irregular. In yet another embodiment, a casualty event may be identified by monitoring the temperature of the avian that enters the field of view. A change in temperature may indicate a casualty event.

At step 406, potential casualties are reviewed to determine if there is an actual fatality, injury, or neither. A fatality is generally identified when the object entering the field of view does not leave, and is described in more detail below. An avian injury is generally identified when the object entering the field of view leaves the field of view very slowly, or moves minimally after entering the field of view. When the object entering the field of view leaves the field of view, it is generally determined to be neither a fatality nor an injury. Still further, avian casualty events may be reviewed by a researcher for confirmation. Such information can be useful to train a machine learning model.

At optional step 408, the location of the avian fatality is identified. This information can be relayed to a researcher who is able to go find the carcass of the avian. The location may be provided as GPS coordinates, a distance and azimuth from the wind turbine, or other ways of determining the location of the avian.

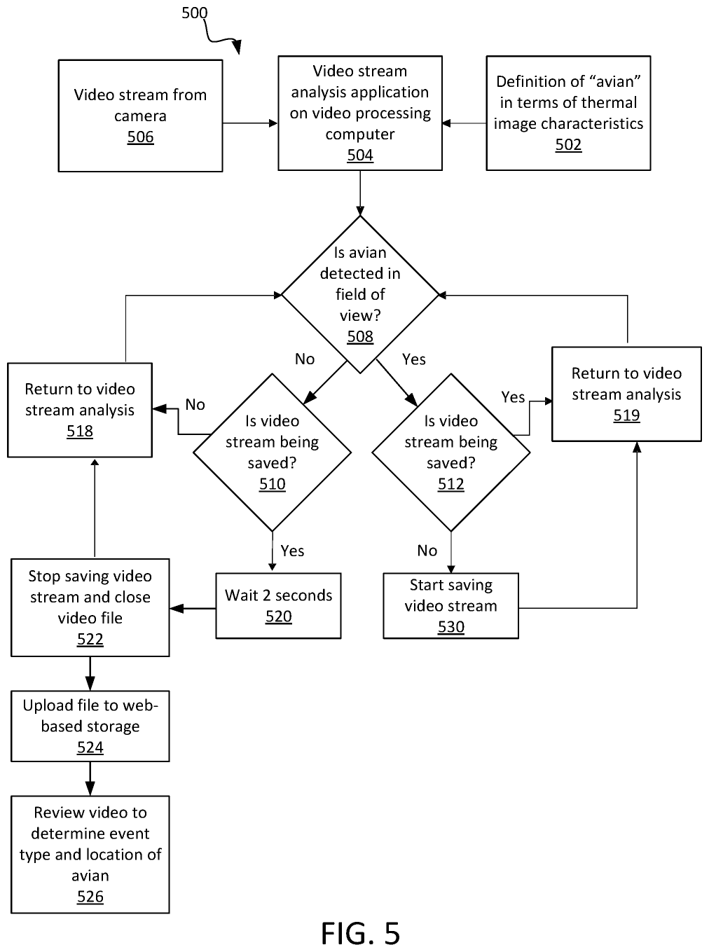

FIG. 5 illustrates a method 500 of determining when an avian is present in the field of view and recording a video of the avian while it remains in the field of view. Method 500 utilizes a thermal imaging camera to determine the thermal characteristics of an object that has entered the field of view and records a video of the object as it moves through the field of view or remains within the field of view. The object is identified as an object having different thermal characteristics than the background environment. The video clip is saved and uploaded for further analysis.

At step 502, a definition of “avian,” in terms of thermal imagery, specifying the characteristics of avians as sensed by a thermal infrared camera, is provided to a computer system running an image analysis application. The definition includes sufficient information to correctly identify objects within the camera field of view as avians, which includes flying animals, specifically as birds and bats, while also bypassing areas of the field of view that do not contain avians. The definition may specify that an avian is identified as a contiguous group of similarly-valued pixels (blob) having a radiated infrared energy that is greater or less than the background surface as measured by a thermal infrared sensor, or a radiated infrared energy that is within a predetermined range of values as measured by a thermal infrared sensor. Other characteristics including the size, shape, or dimensions of the blob, may also be used to distinguish avians from non-avian objects and surfaces.

At step 504, an image analysis application is executed on the computing system. The computing system is configured to receive and process a digital video stream from a thermal camera. It is also configured to save the video stream to a video file on a local drive and determine whether the video stream is currently being saved to a video file.

The terms “video stream” and “video file” are not to be seen as limiting. For example, other types of image capture may be utilized, such as radiometric image sequencing, thermal imaging, burst photo capture, and other similar types of image capturing.

At step 506, a digital video stream from the thermal camera is transmitted by cable connection to the computing system where an image analysis program is running. The image capture device 110 may be tuned to isolate objects having thermal radiance similar to that of avians and filter out objects and surfaces outside the temperature range of avians.

At step 508, the application determines whether an avian is present in the current image of the video stream by determining whether any area of the image meets the definition of an avian provided at step 502.

If no avian is detected, the process moves to step 510. At step 510, the application determines whether the video stream is currently being saved to file. The video stream may be saved locally, or optimally, to a cloud server.

If the application determines that the video stream is not being saved, then the method 500 moves to step 518. At step 518, the method 500 returns to the video stream analysis of step 508 and analyzes the next image in the video stream.

If the application determines that the video stream is being saved, then the method 500 moves to step 520. At step 520, the application waits for two seconds to capture additional video footage after the avian has left the field of view. In alternative embodiments, the application may record for more or less time after the avian has left the field of view depending on the speed of the avian.

At step 522, the application concludes recording and finalizes saving the video file to the local drive with the name of the camera, date, and time included in the file name. The video file may also be stored to a cloud server with the name of the camera, date, and time included in the file name for immediate access by other application and/or researchers.

At step 524, the video file is uploaded over an internet connection to a web-based storage location if the video file was stored locally.

At step 526, the video file is viewed, analyzed, or processed by additional applications or users, such as researchers, of the system. In an embodiment, it is assumed that the object detected is an avian. In a further embodiment, an avian detection application identifies what type of animal the object is, such as a bird or bat, and how big the detected animal is. In an embodiment, the number of casualties may be determined by counting the number of videos depicting casualties.

If, at step 508, the application determines that an avian is present in the current image, then the method 500 moves to step 512. Step 512 determines whether the video stream is being saved.

If the video stream is not being saved, then the method 500 moves to step 530. At step 530, having determined that an avian is present and a video is not being recorded, the application creates a new video container file on the local drive and begins saving the video stream to file. The application then analyzes the next image in the stream.

If the video stream is being saved, then the method 500 moves to step 519, where the method 500 returns to video stream analysis, and then back to step 508, where the application determines if an avian is detected in the field of view.

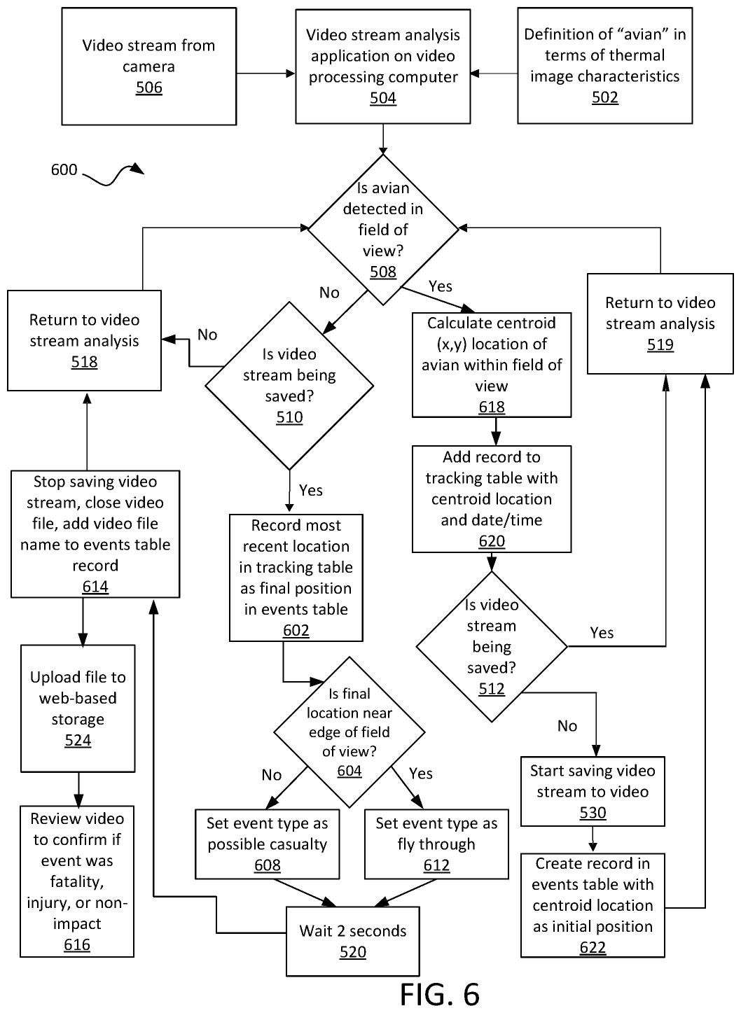

FIG. 6 illustrates a method 600 for determining whether an avian casualty has occurred based on the location within the field of view where the object disappears from the field of view. The process also includes methods for tracking the movement of avians throughout the field of view and recording video of events which are classified as casualties or non-casualties (for example, healthy avians flying through the field of view).

At step 502, a definition of avian is provided to a computing system running an image analysis application, as is described above. At step 506, an input to the computing system is a video stream from a thermal camera, which was described above and is omitted here for brevity. At step 504, the video stream analysis application on a video processing computer receives the video stream from the camera, and the definition of avian.

At step 508, the application determines whether an avian is present in the current image. If no avian is detected, the method 600 moves to step 510 and the application determines whether the video stream is being saved. If the application determines the video stream is not being saved, the method 600 moves to step 518. At step 518, the application returns to process the next available image in the stream.

If, at step 510, the video stream is currently being saved, the method 600 proceeds to step 602. At step 602, the application records the most recent location of the avian in the tracking table as a final position in the events table.

At step 604, the application calculates the distance between the final position of the avian and the edge of the field of view. The application determines whether this distance is greater or lesser than a predetermined estimate of the maximum distance an avian could travel in the time between camera frames (for example, 33 milliseconds for a camera with image frequency 30 Hz). Other speeds are contemplated, depending on the type of avian.

If the final location is not near an edge of the field of view, then the method 600 moves to step 608. At step 608, the event is classified a possible casualty “PC” in the events record based on the evidence from step 604 that the animal did not fly out of the field of view.

At step 604, if the application determines that the final location of the avian is within a distance from the edge of the field of view to indicate that the avian exited the frame propelled by its own flight, then the method moves to step 612.

At step 612, the application classifies the event as a non-casualty fly through “FT” in the event record based on the evidence that the avian exited the frame in the normal course of flight.

At step 520, the video recording continues for two seconds after the final avian location is observed to retain any observable details of the event occurring soon after the avians exit. In alternative embodiments, the application may record for more or less time after the avian has left the field of view depending on the speed of the avian.

After waiting two seconds, the method moves to step 614. At step 614, the video recording is concluded, the file is closed, and saved to the drive with a file name including the camera identity and the date and time of the event. This file name is added to the events record.

At step 524, the application uploads the video to a web-based storage location. The video file is stored to a cloud server with the name of the camera, date, and time included in the file name for immediate access by other application and/or researchers.

In an example embodiment, at step 616, after the video has been uploaded at step 524, the video may be visually reviewed, processed, or analyzed further to confirm the event type designation assigned by the application at step 604. This further analysis may be used to assess the efficacy or accuracy of the method 600. The review may be conducted by a machine learning application, a researcher, or both.

At step 508, if the application determines that an avian is detected in the field of view, then the method 600 moves to step 618. At step 618, the application calculates the centroid (geometric center) of a blob of similarly-valued pixels depicting the avian. The application returns the x and y coordinates of the camera pixel containing the centroid. Coordinates correspond to the location of the avian within the camera field of view. In an alternative embodiment, the coordinates may correspond to a GPS location and/or a location relative to the wind turbine.

At step 620, the application creates a new record in the tracking table and adds the x and y coordinates, as well as the date and time of the observation to the record.

At step 512, the application determines whether the video stream is being saved to the local drive. If the application determines no file is being saved, then the method moves to step 530, where the application begins saving the video stream to a video file on the local drive.

At step 622, the application creates a new record in the events table in the database and adds the centroid position tuple (x, y) calculated at step 618 and recorded in the tracking table at step 620 as the initial position in the newly created events record.

After completing step 622, the application then returns to process the next image in the stream at step 519.

If, at step 512, the application determines that the video stream is already being saved, the application proceeds to process the next image in the stream at step 519.

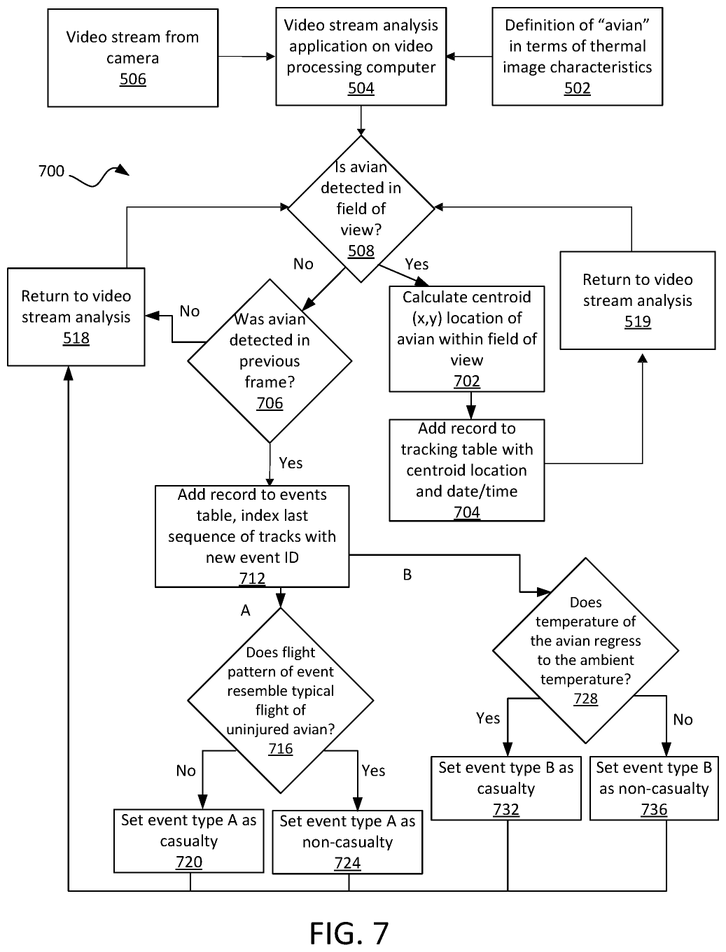

FIG. 7 illustrates an alternative method 700 for detecting avian casualties. The method 700 tracks the flight path and temperature of an avian within the field of view and determines whether a casualty has occurred based on patterns in those data. An embodiment may use either method alone, or both methods in combination.

At step 502, the defining thermal characteristics of avians are provided to an image analysis application, and at step 504 a video stream analysis application runs on a video processing computing system. At step 506, a video stream from a thermal camera is given to the video stream analysis application as an input.

At step 508, the application determines whether an avian is present in the field of view. If an avian is present, the application tracks the location and temperature of the avian and records those data in a table, and the method moves to step 702.

At step 702, the coordinates of the pixel containing the centroid of the thermal blob depicting the avian are determined using the same method as described at step 618. The temperature of the center of the blob is also identified as the value of the centroid pixel.

At step 704, the application creates a new record in the tracking table 802 and adds the location coordinates and temperature reading determined at step 702. The location coordinates may also include a GPS location and/or a location relative to the wind turbine. The application also adds the current date and time to the newly created record in the tracking table.

After completing step 704, the method 700 moves to step 519, where the application then returns to analyze the next image in the video stream.

If an avian is not detected in the field of view at step 508, the method moves to step 706. At step 706, the application determines whether an avian was recorded in the previous frame by searching the tracking table for a record containing the frame identification number of the previous image.

If, at step 706, the application determines that no avians were detected in the previous image as indicated by the lack of a tracking record for that image, the method 700 moves to step 518. At step 518, the application returns to the video stream analysis to analyze the next image.

If, at step 706, the application determines that an avian was detected in the previous image due to the presence of a tracking record with a frame identification number corresponding to the previous image, the method moves to step 716.

At step 712, the application creates a new record in an events table 850 in a database. The application updates records in the tracking table added at step 704 by setting the events identification number to the EventID index for those tracking records created since the previous avian event.

After step 712, the application can use one of two methods: method A or method B to proceed. If the application uses method A to analyze the avian flight pattern as recorded within the field of view at steps 702 and 704, then the method 700 moves to step 716.

At step 716, the application engages method A by examining various aspects of the flight track recorded as the latest event. Characteristics such as flight speed, direction, orientation, and directional variation may be used to distinguish healthy avians from injured or dead avians.

If the application determines that the flight pattern of the avian does not match those of a healthy avian, the method 700 moves to step 720, where the event is set as a casualty. At step 720, the application updates the events table by setting the event type field corresponding to this method to indicate a casualty. The number of casualties is the number of records in the events table having an event type indicating a casualty.

If the application determines that the flight pattern of the avian matches those of a healthy avian, the method 700 moves to step 724, where the event is set as a non-casualty. At step 724, the application updates the events table by setting the event type field corresponding to this method to indicate a non-casualty.

If, at step 712, the application uses method B to analyze the avian temperature over time as recorded at previous steps 702 and 704. Then the method 700 moves to step 728.

At step 728, the application engages method B by determining whether the avian temperature changes over the course of multiple observations. Healthy avians would maintain a relatively constant body temperature, whereas the temperature of avians suffering a fatal casualty would initially be similar to the temperature of a healthy avian, but over time would regress to the ambient temperature or the temperature of the surface on which they land. If falling into water, an avian may remain thermally visible, but its temperature would drop instantaneously.

If the application determines that the temperature trend of the avian substantially matches that of a healthy avian, the method 700 moves to step 732, where the event is set as a non-casualty. At step 732, the application updates the events table by setting the event type field corresponding to this method to indicate a non-casualty.

If the application determines that the temperature trend of the avian substantially differs from that of a healthy avian, the method 700 moves to step 736, where the event is set as a non-casualty. At step 736, the application updates the events table by setting the event type field corresponding to this method to indicate a casualty. The number of casualties is the number of records in the events table having an event type indicating a casualty.

After any analytical outcome for this method 700 (step 720, 724, 732, or 736), the application returns to analyze the next image in the video stream as in step 519.

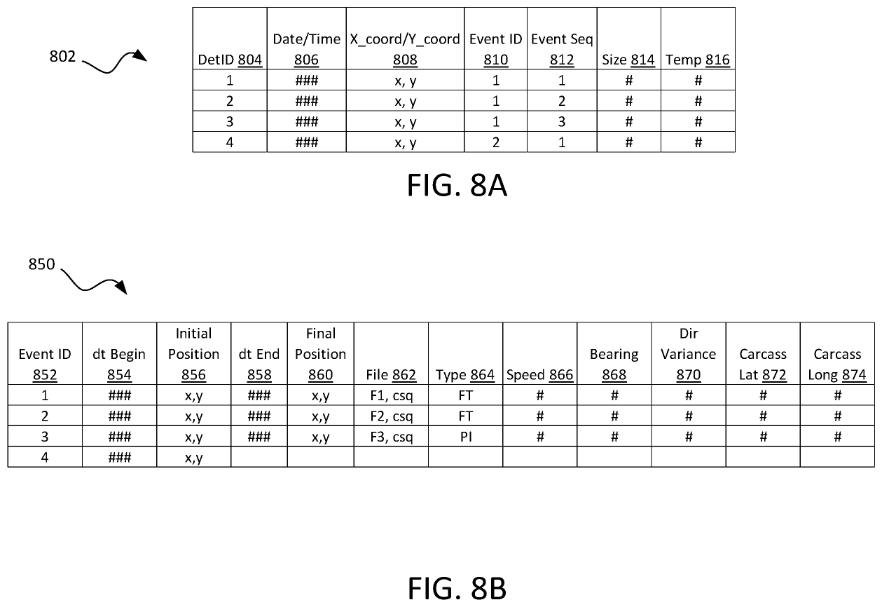

FIGS. 8A and 8B depict an example of two database tables utilized by methods 500, 600, and 700. These tables are populated at several steps in these methods and the stored data are later utilized by subsequent steps.

A tracking table 802 is used to store information pertaining to any avian detected in an image from the thermal camera. The tracking table 802 stores a unique detection identification number 804, the date and time of the detection 806, the x and y coordinates 808 of the pixel containing the centroid of the blob identified as an avian, an event ID 810, an event sequence 812, and may store other details of the detection such as the size of the blob 814, the temperature of the pixel containing the centroid 816, and other measurements from analysis of the image.

An events table 850 is used to store information pertaining to the sequence of tracked points (path) of an avian through the field of view or into the field of view if it does not pass completely through. The events table 850 stores a unique identification number 852 for each event, the date and time 854 of the first detection of the avian, the pixel coordinates 856 of the initial detection location within the field of view, the date and time 858 of the final detection of the avian, and the pixel coordinates 860 of the final detection location within the field of view. The events table 850 also stores the unique file name 862 of the video recording of the avian flight path, the type of event 864 determined, and other characteristics of the event determined by analysis of the sequence of images such as the avian average speed 866, average bearing 868, and directional variance 870.

The events table 850 also stores a latitude 872 of the carcass and a longitude 874 of the carcass at the last detected location of the avian, calculated as described below at method 1000.

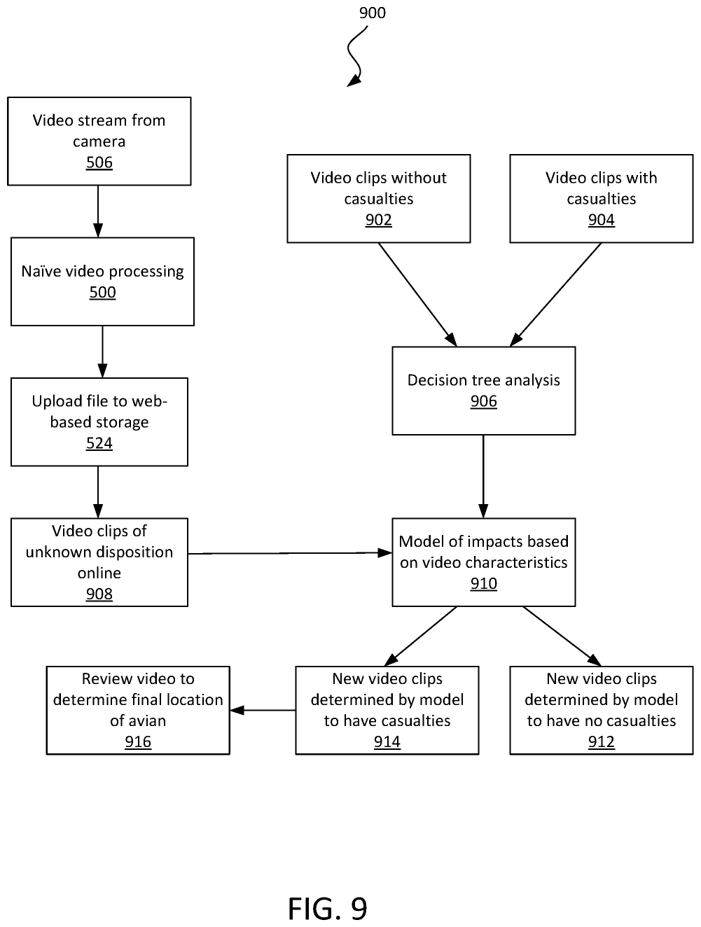

FIG. 9 illustrates a method 900 of identifying casualties from a collection of video clips depicting events that may or may not include casualties. Such a method 900 may be useful for training a machine learning model.

At step 902, a large collection of previously recorded and analyzed video clips known not to include casualties is copied into a directory within a computing system.

At step 904, a large collection of previously recorded and analyzed video clips known to include casualties is copied into a directory within a computing system.

At step 906, a third-party application is used to perform a decision tree analysis to find the characteristics of video clips that are most effective at distinguishing non-casualty clips from casualty clips. The application constructs a model for determining whether a video clip contains a casualty.

At step 506, a video stream is provided to a computing system running an avian detection application. The method 500 is used to record video clips of avians within the camera's field of view, which is described above at FIG. 5. Then, at step 524, the clips are uploaded to a web-based storage location.

At step 908, a collection of unclassified video clips are downloaded from the storage location into a directory accessible by the computing system used to perform decision tree analysis.

At step 910, the third-party application applies the model learned by analysis of the clips provided at steps 902 and 904 to the new clips from step 908.

At step 912, the application identifies a subset of video clips from step 908 that do not have casualties.

At step 914, the application identifies a subset of video clips from step 908 that do have casualties. The number of casualties is the number of clips identified at step 914.

Clips identified as casualties at step 914 are inputs to step 916 to determine the final location of the avians involved in casualties.

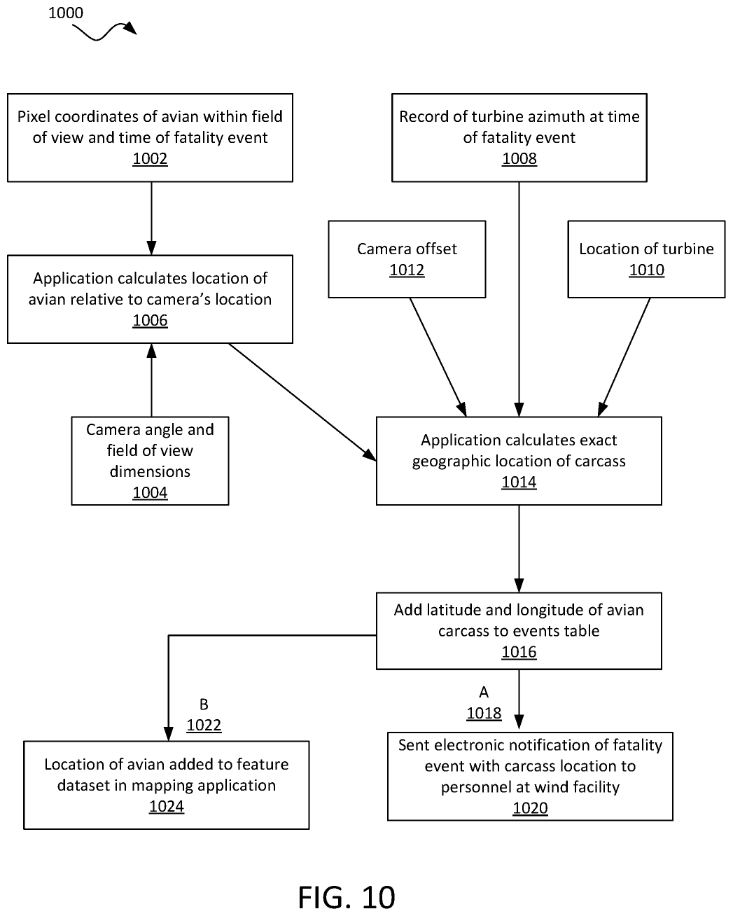

FIG. 10 illustrates a method 1000 of determining the geographic location of an avian and relaying that information to researchers or personnel at a wind energy facility.

At step 1002, an application reads the pixel coordinates of the final position of the avian within the camera field of view from the events table.

At step 1004, the camera angle and field of view dimensions, as determined by the camera angle relative to the ground and the horizontal and vertical angle of view provided by the lens, are provided to the application.

At step 1006, the application calculates the location of the avian relative to the camera's location and directional azimuth.

At step 1008, the turbine nacelle azimuth at the time of the final detection of the avian is recorded and provided to the application.

At step 1010, the precise geographic location (exact latitude and longitude) of the central vertical axis of the turbine tower is provided to the application.

At step 1012, the camera offset, defined as the distance between the center vertical axis of the turbine tower and the camera lens, is provided to the application.

At step 1014, the application calculates the exact geographic location of the avian carcass based on the inputs from steps 1006, 1008, 1010, and 1012.

At step 1016, the latitude and longitude of the avian are added to the corresponding record in the events table.

In example embodiment A 1018, the program transmits the location information via electronic message.

At step 1020, the population of fields of the tracking table causes the application to generate an electronic communication (email, text, or via other third-party application) and send it to predetermined phone numbers or email addresses to be received by personnel at the wind energy facility.

In alternate embodiment B 1022, the application updates an interactive map of casualty locations.

At step 1024, the application appends the location coordinates to a point feature dataset in a remote database hosted by a third-party web-based mapping application.

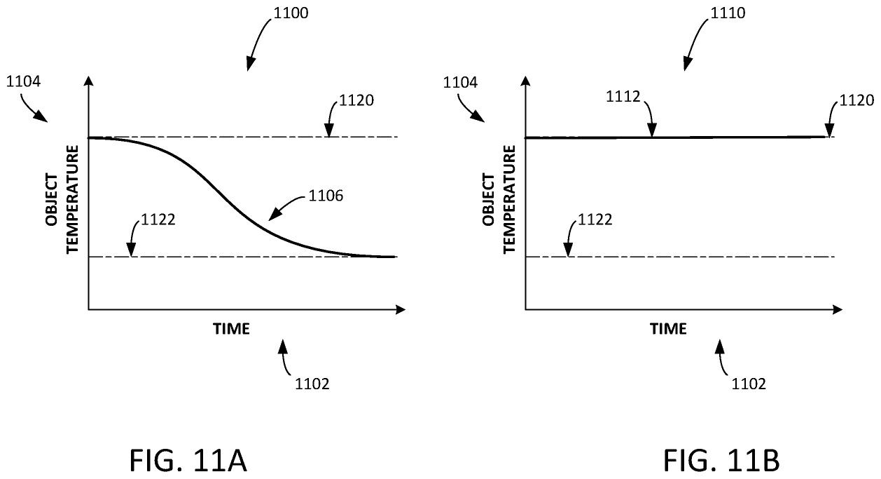

FIG. 11A illustrates an example graph 1100 depicting an avian fatality determined by monitoring the temperature of the previously heated object. The graph 1100 includes measuring object temperature 1104 as a function of time 1102. The dashed line 1120 depicts the static temperature of an avian. The dashed line 1122 depicts the static temperature of the ambient environment. When an avian is killed by the wind turbine, it lands within the field of view and its body temperature regresses to the temperature of the ambient environment. This is depicted by the curve 1106, demonstrating the temperature of the object decreases over time.

FIG. 11B illustrates an example graph 1110 depicting when there is no avian fatality determined by monitoring the temperature of the heated object. The graph 1110 includes measuring object temperature 1104 as a function of time 1102. The dashed line 1120 depicts the static temperature of an avian. The dashed line 1122 depicts the static temperature of the ambient environment. When an avian is not killed by the wind turbine, it continues through the field of view and its body temperature remains constant, or fairly constant. An avian may also confidentially land in the field of view, but since the temperature of the avian does not change, it is determined that the avian has not suffered a casualty. This is depicted by the curve 1112, demonstrating the temperature of the object remains constant over time.

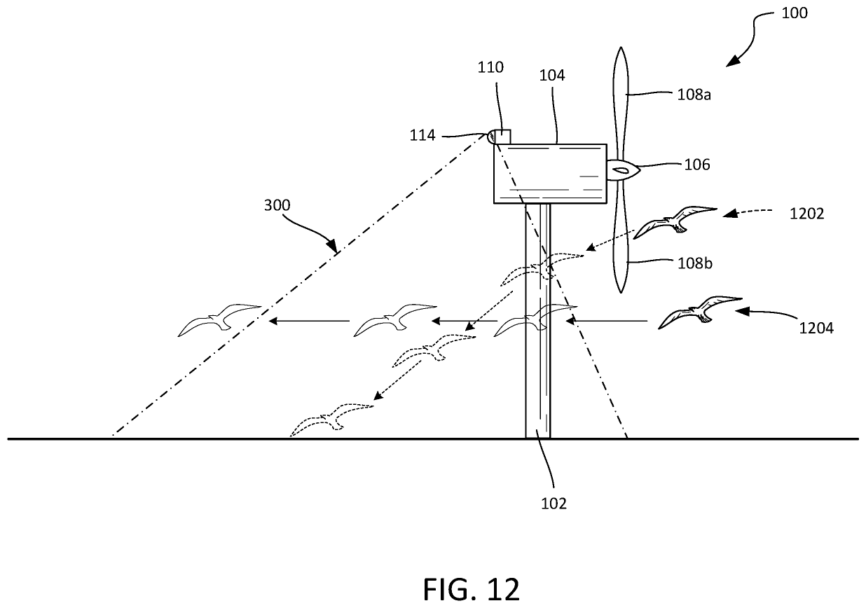

FIG. 12 illustrates an alternative embodiment of detecting avian casualties. The wind turbine 100 includes the tower 102 with the nacelle 104 sitting atop the tower 102. A rotor 106 with a plurality of blades 108a, 108b extends from the nacelle 104 in a first direction. An image capture device 110 extends from the nacelle 104 in an opposing direction. The image capture device 110 includes a lens that faces downward towards the ground to define a field of view 300.

A flight path 1204 of an avian that is not impacted by the blades 108a, 108b is shown as a continuous path. Such a flight path 1204 is identified as a standard and/or predictable flight path of an avian. When a detected flight path 1204 follows a predicted path, it is determined that the avian has not suffered a casualty from the blades 108a, 108b. The flight path 1202 is of an avian that has suffered a casualty. For example, the avian may have been impacted by a blade 108, and has an abnormal or unpredictable flight path 1202. When the detected flight path 1202 follows an unpredicted path and/or a path that follows the laws of gravity for a free falling object, it is determined that the avian has suffered a casualty from the blades 108a, 108b.

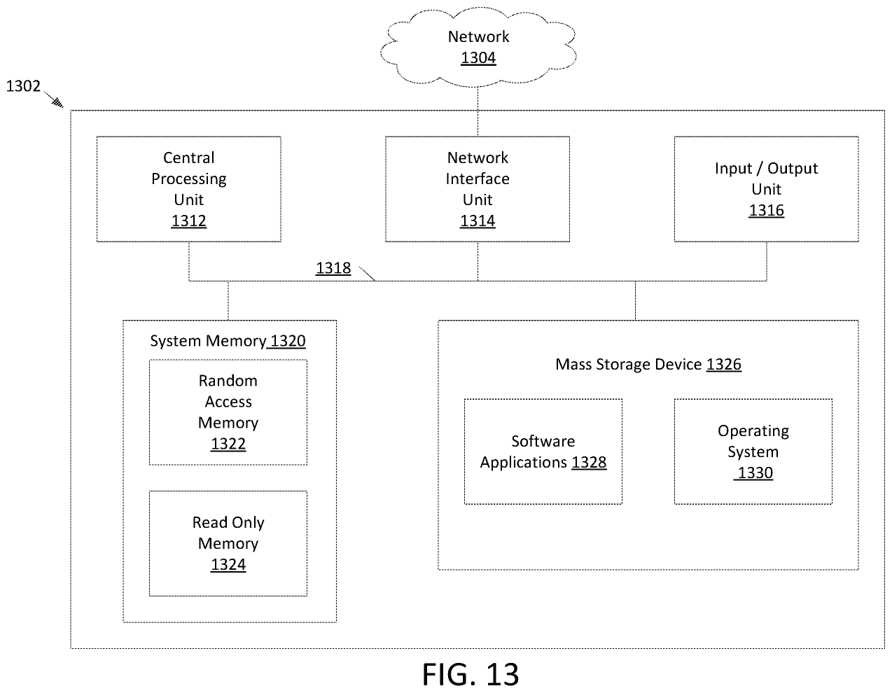

Referring now to FIG. 13, an example block diagram of a computing system 1302 is shown that is useable to implement aspects of the monitoring system described above. In the embodiment shown, the computing system 1302 includes at least one central processing unit (“CPU”) 1312, a system memory 1320, and a system bus 1318 that couples the system memory 1320 to the CPU 1312. The system memory 1320 includes a random access memory (“RAM”) 1322 and a read-only memory (“ROM”) 1324. A basic input/output system that contains the basic routines that help to transfer information between elements within the computing system 1302, such as during startup, is stored in the ROM 1324. The computing system 1302 further includes a mass storage device 1326. The mass storage device 1326 is able to store software instructions and data.

The mass storage device 1326 is connected to the CPU 1312 through a mass storage controller (not shown) connected to the system bus 1318. The mass storage device 1326 and its associated computer-readable storage media provide non-volatile, non-transitory data storage for the computing system 1302. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 1312 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 1302.

According to various embodiments of the invention, the computing system 1302 may operate in a networked environment using logical connections to remote network devices through a network 1304, such as a wireless network, the Internet, or another type of network. The computing system 1302 may connect to the network 1304 through a network interface unit 1314 connected to the system bus 1318. It should be appreciated that the network interface unit 1314 may also be utilized to connect to other types of networks and remote computing systems. The computing system 1302 also includes an input/output unit 1316 for receiving and processing input from a number of other devices, including a touch user interface display screen, or another type of input device. Similarly, the input/output unit 1316 may provide output to a touch user interface display screen or other type of output device.

As mentioned briefly above, the mass storage device 1326 and the RAM 1322 of the computing system 1302 can store software instructions and data. The software instructions include an operating system 1330 suitable for controlling the operation of the computing system 1302. The mass storage device 1326 and/or the RAM 1322 also store software instructions, that when executed by the CPU 1312, cause the computing system 1302 to provide the functionality discussed in this document. For example, the mass storage device 1326 and/or the RAM 1322 can store software instructions that, when executed by the CPU 1312, cause the computing system 1302 to receive and analyze inventory and demand data.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

Similarly, where steps of a process are disclosed, those steps are described for purposes of illustrating the present methods and systems and are not intended to limit the disclosure to a particular sequence of steps. For example, the steps can be performed in differing order, two or more steps can be performed concurrently, additional steps can be performed, and disclosed steps can be excluded without departing from the present disclosure.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A system of detecting avian casualties near a wind turbine, the system comprising:
a computing system including at least one computing device, the computing system having at least one processor communicatively coupled to a memory, the memory storing computer-executable instructions comprising a software tool, which, when executed, causes the computing system to:
determine a field of view;
determine whether an avian is detected within the field of view;
wherein when the avian is detected in the field of view, determine a location of the avian and save the location in a lookup table; and
wherein when no avian is detected within the field of view, record a most recent location of the avian in the lookup table, and determine if a final location is near an edge of the field of view.

2. The system of claim 1, wherein when the final location of the avian is near the edge of the field of view, determine that an avian event was a fly-through.

3. The system of claim 1, wherein when the final location of the avian is not near the edge of the field of view, determine that an avian event was a possible casualty.

4. The system of claim 3, further comprising reviewing a video of the avian event to determine if the avian event was a casualty event selected from a fatality and an injury, or a non-impact event.

5. The system of claim 1, wherein a fatality is determined by identifying an abnormality in a flight path of the avian as it passes through the field of view.

6. The system of claim 1, wherein detecting the avian comprises identifying an object having a thermal characteristic of the avian.

7. The system of claim 6, wherein a fatality is determined by identifying the avian that enters the field of view, but does not exit the field of view.

8. The system of claim 6, wherein a fatality is determined by identifying the avian when entering the field of view and detecting a change in a temperature of the avian while in the field of view.

9. The system of claim 4, wherein a landing location of the avian suffering the casualty event is identified.

10. The system of claim 9, wherein the location is selected from a geographical coordinate and a location relative to the wind turbine.

11. The system of claim 4, wherein determining whether a casualty event has occurred is processed by a machine learning model.

12. A method of detecting avian casualties near a wind turbine, the method comprising:
determining a field of view;
determining whether an avian is detected within the field of view;
wherein when the avian is detected in the field of view, determining a location of the avian and saving the location in a lookup table; and
wherein when no avian is detected within the field of view, recording a most recent location of the avian in the lookup table, and determining if a final location is near an edge of the field of view.

13. The method of claim 12, wherein when the final location of the avian is not near the edge of the field of view, determine that an avian event was a possible casualty.

14. The method of claim 13, further comprising reviewing a video recording of the avian event to determine if the avian event was a casualty event selected from a fatality and an injury, or a non-impact event.

15. The method of claim 12, wherein a fatality is determined by identifying an abnormality in a flight path of the avian as it passes through the field of view.

16. The method of claim 12, wherein detecting the avian comprises identifying an object having a thermal characteristic of the avian.

17. The method of claim 14, wherein when the avian event is a casualty event, uploading the video recording of the casualty event to a web-based storage.

18. The method of claim 14, wherein a landing location of the avian suffering the casualty event is identified.

19. The method of claim 18, wherein the landing location is selected from a geographical coordinate and a location relative to the wind turbine.

20. A system of detecting avian casualties near a wind turbine, the system comprising:
a thermal imaging camera mounted on a rear of a nacelle or tower of the wind turbine;
a computing system connected to the thermal imaging camera, the computing system including at least one computing device, the computing system having at least one processor communicatively coupled to a memory, the memory storing computer-executable instructions comprising a software tool, which, when executed, causes the computing system to:
determine a field of view;
determine whether an avian is detected within the field of view;
wherein when the avian is detected in the field of view, determine a location of the avian and save the location in a lookup table; and
wherein when no avian is detected within the field of view, record a most recent location of the avian in the lookup table, and determine whether a casualty event has occurred via a flight pattern analysis or a change in avian temperature analysis.
